(19) United States
(12) Patent Application Publication
(10) Pub. No.: US 2026/0220275 A1
(43) Pub. Date: Jul. 30, 2026

(54) MALICIOUS URL DETECTION AND REMEDIATION FOR COLLABORATION-BASED SAAS APPLICATIONS

(71) Applicant: Palo Alto Networks, Inc., Santa Clara, CA (US)

(72) Inventors: Mayank Bhatnagar, Bangalore (IN); Arpit Bhatt, Bangalore (IN); Chandan Sajjan Agarwal, Cupertino, CA (US)

(21) Appl. No.: 19/041,120

(22) Filed: Jan. 30, 2025

(51) Int. Cl. G06F 21/57; G06F 21/53; G06F 21/56

(52) U.S. Cl. CPC G06F 21/577; G06F 21/53; G06F 21/566

(57) ABSTRACT

A SaaS application URL monitoring service obtains messages sent in a SaaS application. For each message determined to include a URL, the service extracts the URL from the message and forwards the URL to a URL security service for analysis. The URL security service returns a verdict for the URL indicating a category with which the URL is associated. The service performs a remediation action for each message determined to include a URL categorized as non-benign and/or high risk. If a URL is categorized as malicious (e.g., as a phishing URL), the service modifies the corresponding message in the SaaS application to remove the URL. If a URL is categorized as unknown but high risk, the service modifies the URL included in the corresponding message to redirect to a secure, isolated environment in which the resource corresponding to the unknown, high- risk URL is accessed.

### BACKGROUND

The disclosure generally relates to data processing (e.g., CPC subclass G06F) and to security arrangements for protecting computers, components thereof, programs, or data against unauthorized activity (e.g., CPC subclass G06F 21/00).

Uniform resource locators (URLs) are commonly leveraged in carrying out web-based cyber attacks. For instance, URLs can be used to carry out phishing scams, in which URLs are crafted to mimic trusted websites, thus increasing the likelihood that users will click on a link comprising the URL or navigate to the corresponding resource. These phishing URLs often direct users to fraudulent login pages or websites designed to harvest personal information, credentials, financial information, and the like from unsuspecting users. Other malicious URLs can be associated with websites that host malicious content, such as websites that download and install malware upon access.

The Software-as-a-Service (SaaS) model is a model for distributing cloud- hosted software over the Internet. In contrast to on-premises software, which is hosted on-site rather than remotely, SaaS applications are hosted on cloud infrastructure. SaaS applications are often made available as cloud-hosted web applications that can be accessed by end users via web browsers.

### BRIEF DESCRIPTION OF THE DRAWINGS

Embodiments of the disclosure may be better understood by referencing the accompanying drawings.

FIG. 1 is a conceptual diagram of reducing the risk associated with unsafe URLs shared in messages within a SaaS application.

FIG. 2 is a conceptual diagram of reducing risk associated with high risk and unsafe URLs shared in messages within a SaaS application.

FIG. 3 is a flowchart of example operations for detecting and remediating unsafe or risky URLs sent within a SaaS application.

FIG. 4 is a flowchart of example operations for modifying a SaaS application message to remove/obfuscate or replace a URL based on a category of the URL.

FIG. 5 is a flowchart of example operations for determining exposure of a malicious/phishing URL to SaaS application users.

FIG. 6 depicts an example computer system with a SaaS application URL monitoring service and a URL parser.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the term "message" in the context of SaaS applications. A message is a unit of communication sent within the SaaS application by a user of the SaaS application to one or more other users of the SaaS application. Messages can be sent as part of a private conversation between two or more users (e.g., direct messages), posted in a channel within the SaaS application, and/or sent as replies to an original message(s) posted in a channel.

Use of the phrase "at least one of' preceding a list with the conjunction "and" should not be treated as an exclusive list and should not be construed as a list of categories with one item from each category, unless specifically stated otherwise. A clause that recites "at least one of A, B, and C" can be infringed with only one of the listed items, multiple of the listed items, and one or more of the items in the list and another item not listed.

### Overview

Collaboration-based SaaS applications that allow for messaging between and among users, particularly those used in workplace environments, are not conventionally a target for security analysis of URLs shared in messages sent within the SaaS application environment. There is thus a risk that URLs shared in SaaS applications are associated with phishing attacks or are otherwise malicious or high risk but will go undetected. To address this, a SaaS application URL monitoring service (hereinafter simply "the service") disclosed herein analyzes URLs identified in messages sent within SaaS applications to determine whether shared URLs are malicious, associated with phishing attacks, or are otherwise high risk. The service modifies messages that include such URLs to remove or modify these URLs directly within the messages, thus preventing spread of these URLs to other users of the SaaS application and beyond.

The service obtains notifications or events indicating contents of messages that are sent (e.g., sent from a user to one or more other users, posted in a channel, etc.) in the SaaS application. The service can obtain the notifications or events indicative of the messages via a connector of the SaaS application, API polling, or a webhook(s) configured for the SaaS application. For those of the messages determined by the service to include a URL, the service extracts the URL from the message and submits the URL to a URL security service (e.g., a URL filtering service, URL scanner, etc.) for analysis. The URL security service returns a verdict for the URL, which indicates if the URL is a known phishing URL or is otherwise malicious, if the URL is benign, or if the URL is unknown. Unknown URLs may be categorized further based on a risk level indicating riskiness of the unknown URL (e.g., low risk or high risk). The service performs a remediation action for each message determined to include a URL identified as being non-benign and/or high risk. If the URL is known to be malicious, such as if the URL is a known phishing URL, the service modifies the message in the SaaS application to remove the URL therefrom. If the URL is unknown but high risk, the service modifies the URL included in the message itself to redirect to a secure, isolated environment in which the resource corresponding to the URL is loaded. This reduces disruptions for end users without exposing the users to security risks associated with accessing unknown, risky URLs. The modifications to the messages made by the service are posted in the SaaS application rapidly to prevent unwanted spread of malicious URLs among users of the SaaS application and further to individuals outside of the context of the SaaS application.

### Example Illustrations

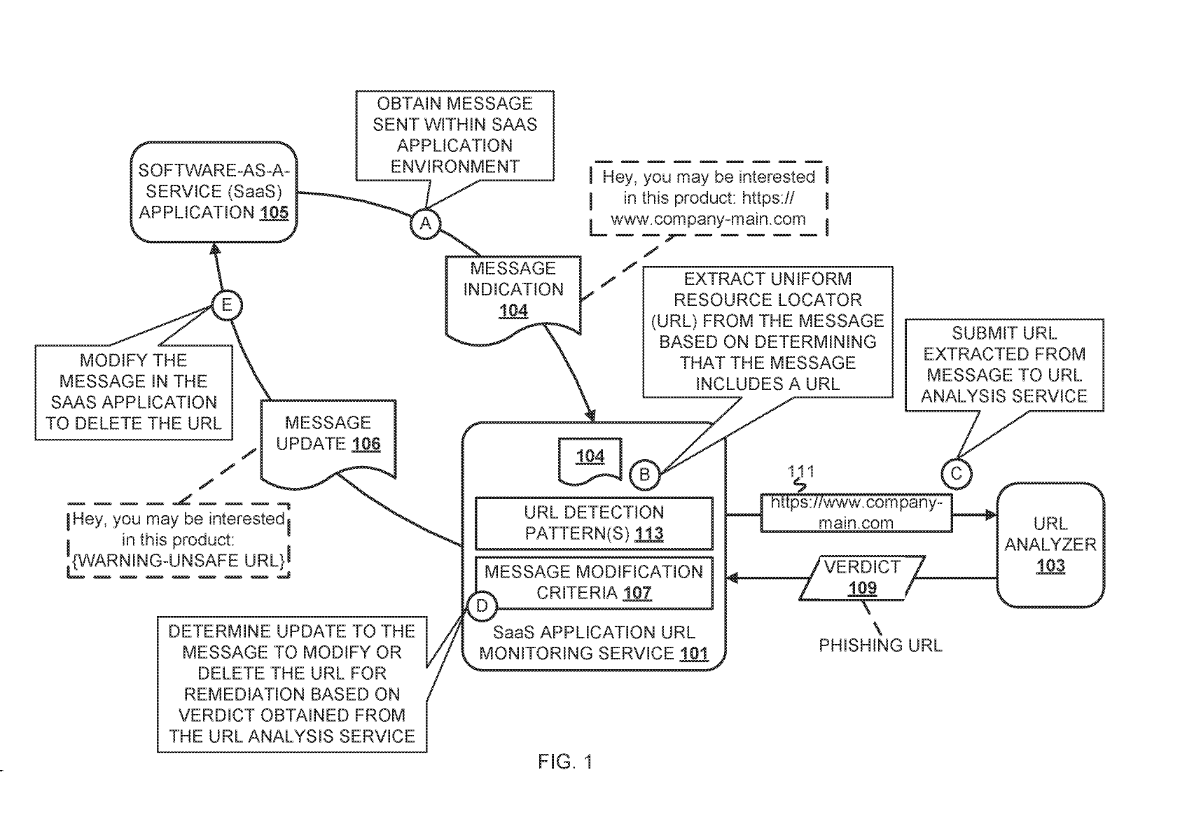

FIG. 1 is a conceptual diagram of reducing the risk associated with unsafe URLs shared in messages within a SaaS application. FIG. 1 depicts a SaaS application URL monitoring service ("monitoring service") 101, which may execute as a cloud-based service. The monitoring service 101 monitors messages sent within a SaaS application 105 for unsafe (e.g., malicious, high risk, etc.) or potentially unsafe URLs and modifies messages that include URLs indicated as being unsafe or potentially unsafe to remove or replace the URLs directly in the message viewable in the SaaS application by the message recipient(s). The SaaS application 105 is a collaboration-based SaaS application, such as a team collaboration/communication application, or a SaaS application that provides messaging functionality for users. As an illustrative example, the SaaS application 105 can be a team collaboration application licensed by an organization for use by its employees. The users of the SaaS application 105 thus refers to the users associated with a tenant licensing the SaaS application 105, such as employees of an organization that are registered as users of the SaaS application 105 with enterprise accounts.

The monitoring service 101 receives indications of messages sent (e.g., in a direct message, posted in a channel, etc.) within the SaaS application 105. For instance, the monitoring service 101 can subscribe to an event stream to which the SaaS application 105 publishes events (e.g., with an event streaming service offered by a provider of the SaaS application 105), where events correspond to sending of messages within the SaaS application. In this case, each event received by the monitoring service 101 corresponds to a message. As another example, the SaaS application 105 can be configured to communicate indications of messages to the monitoring service 101 via an outgoing webhook(s) or a connector that enables sharing of message sent in the SaaS application 105 with an external endpoint (e.g., the Slack® Connector service), where the monitoring service 101 is designated as the external endpoint. As yet another example, the monitoring service 101 can obtain indications of messages via frequent API polling of an API function(s) of the SaaS application 105. Different SaaS applications can offer different functionalities for sharing messages to external services, so the manner in which the monitoring service 101 obtains indications of messages shared in the SaaS application 105 can vary among identities of the SaaS application 105. In any case, message analysis by the monitoring service 101 is out-of-band rather than inline. In other words, the monitoring service 101 obtains copies of messages sent within the SaaS application 105 rather than detecting the messages themselves in the flow of network traffic (e.g., such as if the monitoring service 101 were to execute on a firewall or other cybersecurity appliance that can provide inline network traffic analysis) when preforming out-of-band URL monitoring.

FIG. 1 is annotated with a series of letters A-E. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the monitoring service 101 obtains an indication of a message 104 sent in the SaaS application 105. The indication of the message 104 is a notification, event, etc. indicating contents of the message 104. The message 104 in this example includes the text, "Hey, you may be interested in this product: https://www.company- main.com", where the message 104 includes a URL 111 (depicted as "https://company- main.com" in this example). The URL 111 can be included in the message 104 as plaintext or with a hyperlink. The monitoring service 101 obtains the message 104 based on detection that the message 104 has been sent in the SaaS application 105, such as over an event stream, via a webhook, etc. depending on the functionality offered by the SaaS application 105 for notifying external entities of sent messages and their contents.

At stage B, the monitoring service 101 extracts the URL 111 from the message 104 based on determining that the message 104 includes a URL. The monitoring service 101 comprises one or more URL detection patterns 113 for detecting URLs in messages. The URL detection pattern(s) 113 includes one or more patterns (e.g., regular expressions) for matching text corresponding to URLs sent as plaintext or with hyperlinks. The monitoring service 101 evaluates the message 104 based on the URL detection pattern(s) 113 and, in this example, detects a match for the URL 111. The monitoring service 101 extracts (e.g., copies) the URL 111 from the message 104.

At stage C, the monitoring service 101 submits the URL 111 extracted from the message 104 to a URL analyzer 103. The URL analyzer 103 provides URL security services for determining whether identified URLs are malicious, benign, unknown, etc. The URL analyzer 103 can be a service offered by the cybersecurity provider that also provides the monitoring service 101 or may be a third-party service that the monitoring service 101 utilizes. The monitoring service 101 submits the URL 111 to the URL analyzer 103 for analysis (e.g., via an API of the URL analyzer 103). The monitoring service 101 obtains in response a verdict 109 by the URL analyzer 103 determined based on results of analysis of the URL 111. The verdict 109 in this example indicates that the URL 111 is known to be associated with phishing.

At stage D, the monitoring service 101 determines an update to the message 104 to modify or delete the URL based on the verdict 109 obtained from the URL analyzer 103. The monitoring service 101 evaluates the verdict 109 based on message modification criteria ("criteria") 107. The criteria 107 indicate criteria for modifying messages sent within the SaaS application to remediate the sharing of unsafe or risky URLs in SaaS application 105 messages. Different verdicts can be associated with different actions for remediation (e.g., delete or replace) in the criteria 107. For instance, the criteria 107 can indicate a first criterion that URLs with phishing or other malicious verdicts should be removed from the corresponding messages. The monitoring service 101 determines that this first of the criteria 107 is satisfied based on the phishing verdict 109 of the URL 111.

At stage E, the monitoring service 101 modifies the message 104 in the SaaS application 105 to delete the URL 111 therefrom. The monitoring service 101 generates a message update 106 by which the URL 111 is deleted from the message 104 in the SaaS application 105. The monitoring service 101 updates the message 104 according to the message update 106 by leveraging an API of the SaaS application 105 that provides for modifying posted/sent messages. The monitoring service 101 invokes a function of the SaaS application API for message modification, where the function invocation indicates the message 104 (e.g., with an identifier or other metadata of the message 104) and a deletion command indicating that the URL 111 should be deleted from the message. The monitoring service 101 may have permissions with the SaaS application 105 that allow the monitoring service 101 to modify messages in the SaaS application 105 via its API. As depicted in FIG. 1, the message update 106 for deleting the URL 111 can also indicate text to be inserted in place of the URL or elsewhere in the message 104 indicating that an unsafe URL was included in the message 104. Removal of the URL 111 from the message 104 directly in the SaaS application 105 results in the URL 111 no longer being accessible to the recipient(s) of the message 104.

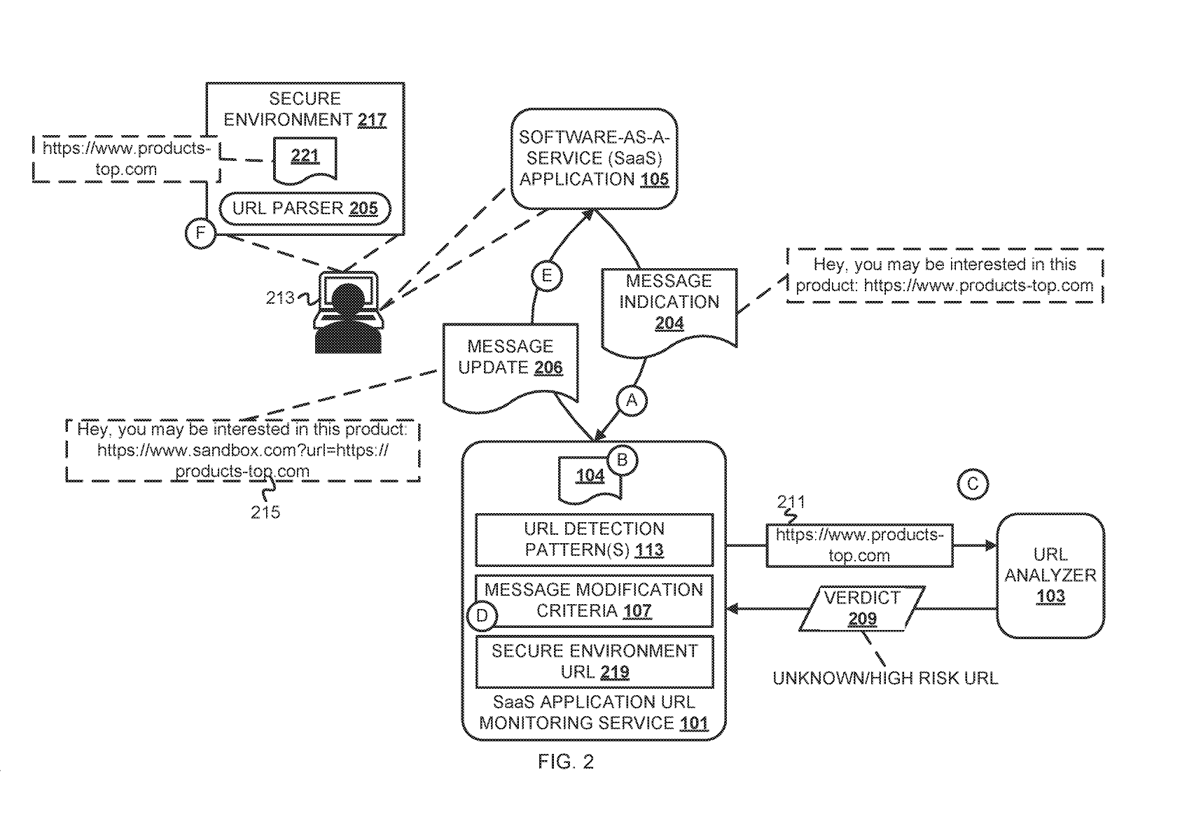

FIG. 2 is a conceptual diagram of reducing risk associated with high risk and unsafe URLs shared in messages within a SaaS application. While FIG. 1 depicted an example of deleting a URL from a message, FIG. 2 depicts a use case of modifying a URL in a message, specifically for the case of URLs determined to be unknown but high risk. FIG. 2 also refers to the monitoring service 101 and the SaaS application 105 of FIG. 1.

FIG. 2 is annotated with a series of letters A-F. Each letter represents a stage of one or more operations. Although these stages are ordered for this example, the stages illustrate one example to aid in understanding this disclosure and should not be used to limit the claims. Subject matter falling within the scope of the claims can vary from what is illustrated. Subject matter described in reference to FIG. 1 that is also included in FIG. 2, namely for the operations corresponding to stages A-C, is not repeated in reference to FIG. 2 for brevity.

At stage A, the monitoring service 101 obtains an indication of a message 204 sent within the SaaS application 105 environment. The message 204 in this example includes the text, "Hey, you may be interested in this product: https://www.products- top.com", which includes a URL 211 (depicted as "https://www.products-top.com" in this example). This example assumes that the message 204 was sent by a user from a client 213 (e.g., a web browser executing on a client device). At stage B, the monitoring service 101 extracts the URL 211 from the message 204 based on determining that the message 204 includes a URL.

At stage C, the monitoring service 101 submits the URL 211 extracted from the message 204 to the URL analyzer 103. The monitoring service 101 obtains a verdict 209 from the URL analyzer 103 indicating that the URL 211 is an unknown but high-risk URL. An unknown but high-risk URL may be a URL that is not known to be either malicious or benign but still has a high level of riskiness associated therewith, such as based on including a domain name that is unknown or has an unknown reputation, based on being classified as a newly registered domain and/or having an age below a threshold, etc.

At stage D, the monitoring service 101 determines an update to the message 204 to modify or delete the URL for remediation based on the verdict obtained from the URL analyzer 103. As described above in reference to FIG. 1, different verdicts can be associated with different actions in the criteria 107. For instance, the criteria 107 can indicate a second criterion that URLs with a "high risk unknown" or similar verdict should be replaced in the corresponding messages with a substitute URL. The monitoring service 101 determines that this second of the criteria 107 is satisfied based on the "high risk unknown" verdict 209 of the URL 211 and generates a substitute URL with which to replace the URL 211, depicted in FIG. 2 as a replacement URL 215.

The monitoring service 101 is configured with a URL 219 of a secure environment 217 (hereinafter the "secure environment URL 219") managed by a same entity (e.g., cybersecurity provider) as the monitoring service 101. For instance, the secure environment 217 may be a sandbox environment accessible over the Internet via the secure environment URL 219. The monitoring service 101 generates the replacement URL 215 with which to replace the URL 211 by appending the URL 211 to the secure environment URL 219. In this example, the monitoring service 101 appends a query string to the secure environment URL 219 that includes a parameter-value pair comprising the URL 211 as a parameter value in the query string. The parameter name that the monitoring service 101 is to use when appending parameter-value pairs to the secure environment URL 219 query string can be a configured setting of the monitoring service 101 such that the parameter name is consistent across replacement URLs that are generated.

At stage E, the monitoring service 101 modifies the message 204 in the SaaS application 105 to replace the URL 211 with the replacement URL 215. The monitoring service 101 generates a message update 206 that replaces the URL 211 in the message 204 with the replacement URL 215. The monitoring service 101 communicates the message update 206 to the SaaS application 105 (e.g., via the API of the SaaS application 105) as similarly described above in reference to FIG. 1 to replace the URL 211 with the replacement URL 215 directly in the message 204. For instance, the monitoring service 101 can invoke a function of the SaaS application 105 to edit the message 204 by replacing the contents corresponding to the URL 211 with the replacement URL 215. Once updated, the message 204 thus includes the replacement URL 215 in place of the URL 211 originally sent.

At stage F, the client 213 navigates to the replacement URL 215 in the secure environment 217. Upon navigation to the replacement URL 215, the client 213 is directed to the secure environment 217 to which the replacement URL 215 corresponds. The secure environment 217 includes a URL parser 205 that parses query strings of URLs to retrieve unknown but high-risk URLs that were included therein by the monitoring service 101. The URL parser 205 recognizes the parameter name included in URL query strings in which the monitoring service 101 has included unknown URLs as a value (the parameter name "url" in this example). The URL parser 205 identifies the URL 211 based on parsing the replacement URL 215 and issues a request (e.g., a Hypertext Transfer Protocol (HTTP) request) for a resource 221 to which the URL 211 corresponds.

Assuming this request is fulfilled with a response comprising a resource 221, the client 213 thus obtains the resource 221 and loads the resource 221 within the secure environment 217. If the URL 211 is benign, the recipient of the message 204 can thus access the resource 221 without service disruptions caused by blocking all unknown URLs, while accessing the resource 221 within the secure environment 217 provides a measure of protection in the event that the URL 211 and thus the resource 221 is malicious. The secure environment 217 or a monitoring agent deployed thereto can also monitor behavior of the resource 221 within the secure environment 217 to inform classification of the URL 211 as malicious or benign, with this information provided to the URL analyzer 103 (or an entity that manages the URL analyzer 103).

FIGS. 1 and 2 depict examples in which the monitoring service 101 detects a single message for clarity and to aid in understanding. In implementations, the monitoring service 101 can comprise a queue in which incoming indications of messages are placed, as the monitoring service 101 may receive large quantities of message indications in short timeframes, particularly in implementations where the monitoring service 101 monitors messages sent among employees within a large organization that leverages the SaaS application 105. The monitoring service 101 can thus retrieve sets of one or more message indications from the queue (e.g., sets of message indications for parallel processing of multiple message indications) for analysis and any modification as described above.

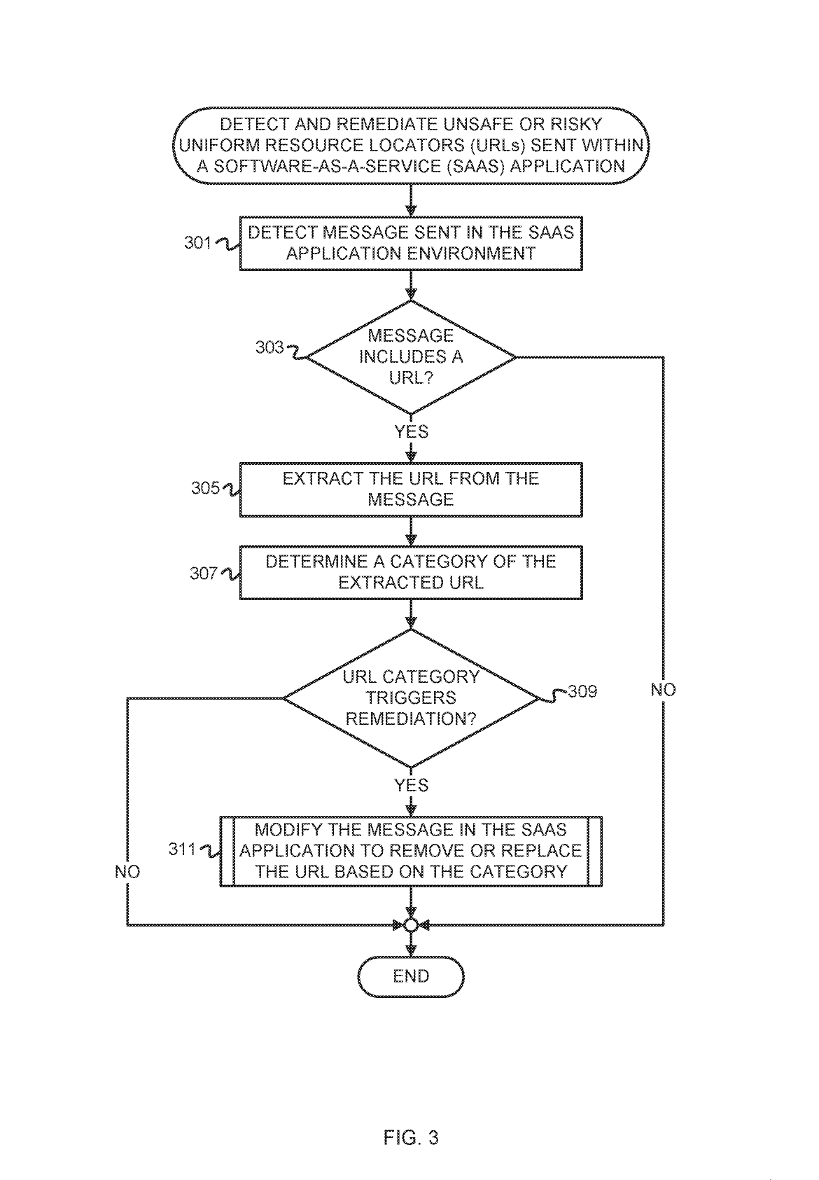

FIGS. 3-5 are flowcharts of example operations. The example operations are described with reference to a SaaS application URL monitoring service (hereinafter "the monitoring service") for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting and remediating unsafe or risky URLs sent within a SaaS application. The example operations assume that the monitoring service is configured to detect messages sent within the SaaS application between/among users. This may be achieved via subscribing to a message stream service offered by the SaaS application, via API polling, via configuration of a webhook(s) configured for messaging events within the SaaS application, etc.

At block 301, the monitoring service detects a message sent in the SaaS application environment. The manner in which the monitoring service detects the message can vary depending on how the monitoring service has been configured to receive messages sent within the SaaS application. The message at least includes content (e.g., textual content, data, etc.) sent from one user of the SaaS application to one or more other users. While referred to as "the message" herein for simplicity, the monitoring service generally obtains indications of messages sent in the SaaS application, which at least includes the contents of messages and any associated metadata, since message analysis by the monitoring service can be performed out-of-band (i.e., as opposed to inline) with respect to the flow of network traffic of the SaaS application.

At block 303, the monitoring service determines if the message includes a URL. The monitoring service evaluates the contents of the message to determine if a URL is included. For instance, the monitoring service can be configured with one or more patterns (e.g., regular expressions) for matching URLs, which can include a pattern(s) for detecting hyperlinks in addition to URLs sent in plaintext. In this case, the monitoring service determines if a match is detected for at least a first pattern based on evaluation of the message. If the message includes a URL, operations continue at block 305. Otherwise, operations are complete, though the monitoring service may forward the message to another service for additional security analysis.

At block 305, the monitoring service extracts the URL from the message. Extracting the URL can include copying the string within the message that matched to the pattern that resulted in detection of the URL.

At block 307, the monitoring service determines a category of the URL. The monitoring service can include or may communicate with a URL security service (e.g., a URL filtering tool or other URL analyzer), which may be made available by the cybersecurity provider that offers the monitoring service or by a third party. The URL security service at least includes functionality to determine if the URL is malicious, benign, or unknown based on URL security knowledge with which it is configured and/or to which it has access. The URL security service also can determine risk levels associated with unknown URLs, such as high risk or low risk, based on data or metadata available for the unknown URLs (e.g., for the domain names included therein). The monitoring service submits the URL to the URL security service and determines the category of the URL based on a response received from the URL security service that includes the verdict, which at least indicates a verdict indicative of whether the URL is malicious, benign, or unknown (and optionally any risk level associated with an unknown URL). For instance, the response from the URL security service can directly indicate a category of the URL, such as whether the URL is malicious, a phishing URL (where phishing URLs may be treated as a specific type of malicious URL that can be detected), benign, low-risk unknown, or high-risk unknown. The monitoring service may instead map a verdict indicated in the response from the URL security service to a corresponding one of a plurality of categories recognized by the monitoring service based on mappings of the categories supported by the monitoring service to corresponding verdicts known for the URL security service. To illustrate, a plurality of categories of URLs can be mapped to a general category of malicious URLs (e.g., URLs classified as related to command-and- control, ransomware, etc.).

At block 309, the monitoring service determines if the URL category triggers remediation. One or more categories recognized by the monitoring service trigger a remediation action(s) to remove or obfuscate the URL from the message or replace the URL in the message. The monitoring service determines if the category determined for the URL matches a category that triggers remediation. Examples of URL categories that generally will trigger remediation include malicious URLs, phishing URLs, and high-risk unknown URLs. If the URL category triggers remediation, operations continue at block 311. Otherwise, operations are complete, though the monitoring service may forward the message to another service for additional security analysis.

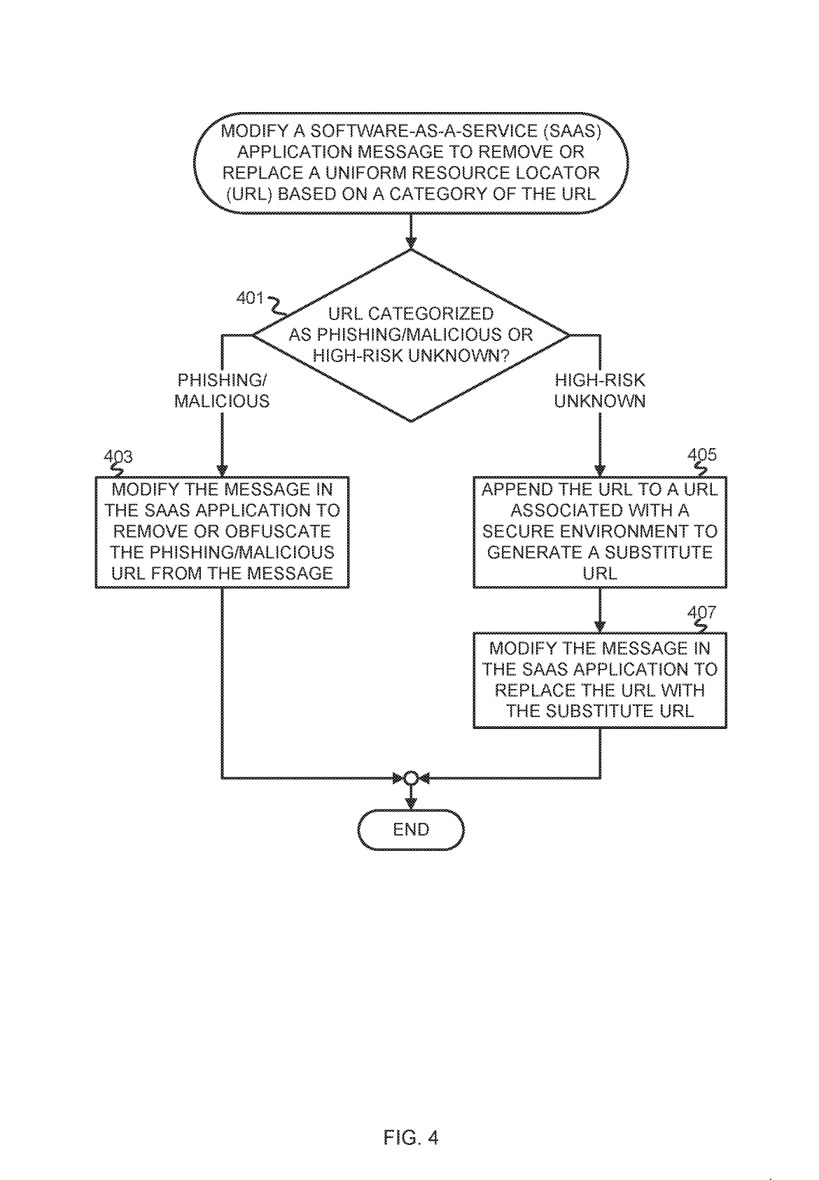

At block 311, the monitoring service modifies the message in the SaaS application to remove or replace the URL based on the category. Different URL categories can trigger different remediation actions, which include whether the URL is removed or obfuscated entirely in the message (such as in the case of known malicious and phishing URLs) or replaced with a different URL that redirects users to a secure environment for navigating to the original URL (such as in the case of high-risk unknown URLs). The monitoring service directly modifies the contents of the message that are visible to the message recipient(s) within the SaaS application environment, thus preventing further distribution of the unsafe or risky URL. Modifying the message to remove/obfuscate or replace the URL based on the URL category is described in further detail in reference to FIG. 4.

FIG. 4 is a flowchart of example operations for modifying a SaaS application message to remove/obfuscate or replace a URL based on a category of the URL. The example operations assume that a URL extracted from a message sent within a SaaS application has been categorized into a category that triggers remediation (i.e., removal/obfuscation or replacement of the URL in the message). This example refers to example categories of phishing URLs/malicious URLs and high-risk unknown URLs, though other categories are anticipated. Additionally, while this example refers to phishing and malicious as separate categories of URLs, whether phishing is a separate category from malicious or is a sub-category of the malicious URL category can vary among implementations.

At block 401, the monitoring service determines if the URL was categorized as phishing/malicious or as high risk and unknown. If the URL was categorized as a phishing URL or a malicious URL, operations continue at block 403. If the URL was categorized as a high-risk unknown URL, operations continue at block 405.

At block 403, the monitoring service modifies the message in the SaaS application to remove or obfuscate the phishing/malicious URL from the message. The monitoring service modifies the message to remove the phishing/malicious URL entirely or to obfuscate the URL within the message such that it is no longer discernible and accessible to the message recipient(s). Modifying the message to remove or obfuscate the URL can be achieved by calling a function(s) of an API of the SaaS application that is available to the monitoring service. For instance, the monitoring service can call a function that deletes messages within the SaaS application, where the function call indicates the message and an action to delete the message entirely. As another example, the monitoring service can call a function that edits messages to replace the URL in the message with a known benign URL and/or a disclaimer indicating that content has been removed from the message. As another example, the monitoring service can edit the entire message via the SaaS application API to replace the contents of the message, including the URL, with a custom message that can be configured by a network/security administrator (e.g., "This message includes content that violates company policy" or the like). With any of these approaches, the monitoring service will remove the phishing/malicious URL from the message, thus rendering it no longer available to the message recipient(s).

At block 405, the monitoring service appends the URL to a URL associated with a secure environment to generate a substitute URL. The monitoring service has been configured with a URL of the secure environment, which is a secure and isolated environment managed by the same entity (e.g., cybersecurity provider) as the monitoring service. For instance, the secure environment may be an Internet-accessible sandbox. The monitoring service appends the URL to the secure environment's URL, such as by including the URL in a query string of the secure environment's URL (e.g., as a value of a parameter with a name that is recognized by the secure environment). If the secure environment's URL already includes a query string, the monitoring service appends a new parameter to the existing query string with the URL as its value; if not, the monitoring service appends a query string to the secure environment's URL that includes such a parameter and corresponding value.

At block 407, the monitoring service modifies the message in the SaaS application to replace the URL with the substitute URL. The monitoring service replaces the URL in the message with the substitute URL (e.g., by invoking an API of the SaaS application with a call to a function for message modification). As an example, the monitoring service can issue a call to a function of the SaaS application API for modifying posted/sent messages that indicates the message, the text to be removed, and the text with which to replace the removed text. (i.e., the URL and the substitute URL, respectively).

When a client (e.g., a web browser) navigates to the substitute URL, the client is directed to the secure environment. A URL parser associated with the secure environment parses the substitute URL to identify the URL of the resource to be accessed based on the value of the parameter in the query string added by the monitoring service. The secure environment then issues a request to retrieve the resource corresponding to the URL identified in the query string and, if the request is fulfilled, the resource is loaded in the secure environment for access by the message recipient(s) that initiated retrieval of the resource. Navigation to the substitute URL thus results in loading of the resource corresponding to the original URL within the secure environment to provide a level of security in the event that the original URL is malicious.

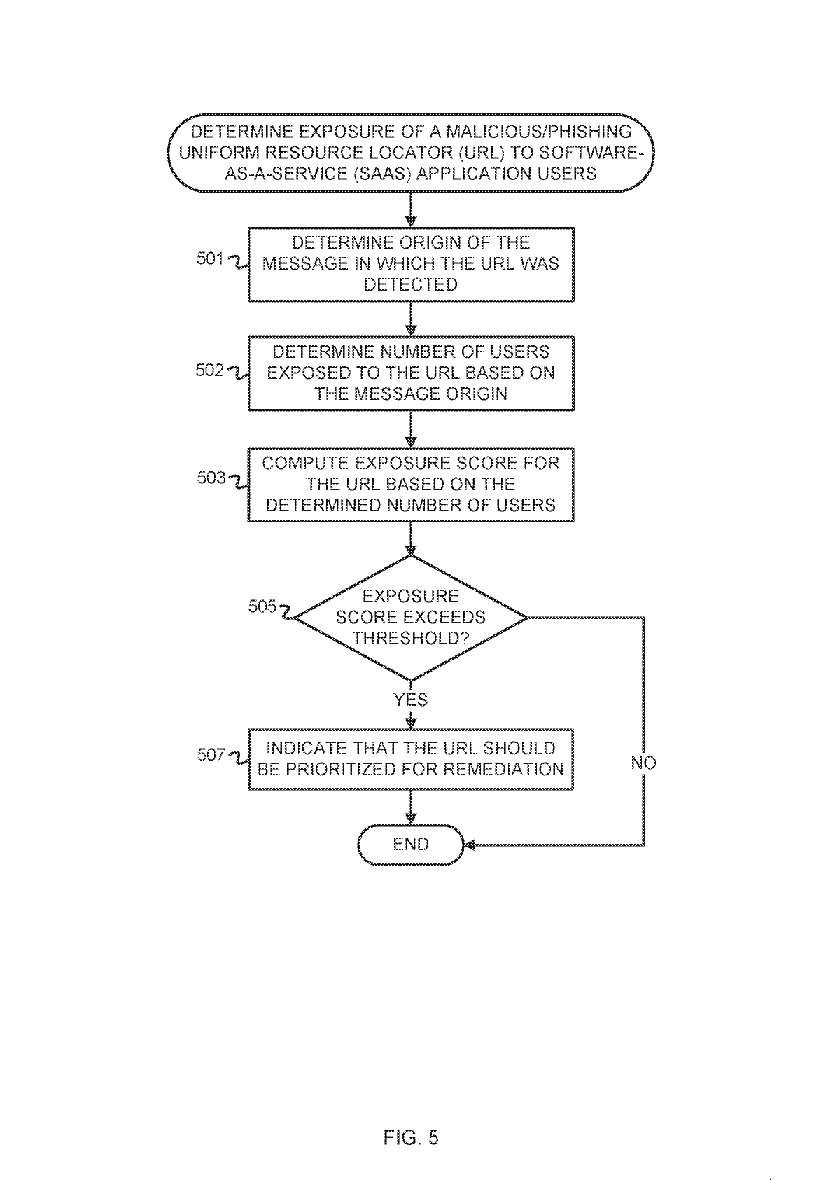

FIG. 5 is a flowchart of example operations for determining exposure of a malicious/phishing URL to SaaS application users. The example operations assume that a URL sent in a SaaS application environment has been categorized as a malicious and/or phishing URL.

At block 501, the monitoring service determines the origin of a message in which the URL was detected. The monitoring service determines the origin of the message based on metadata of the message. The origin of the message indicates whether the message was sent in a direct message to one or more users or in a channel of the SaaS application that has multiple users as members.

At block 502, the monitoring service determines the number of users that have been exposed to the URL based on the origin of the message. If the message originated in a direct message, the monitoring service can determine the number of users based on the number of recipients of the direct message (e.g., indicated in the message metadata). If the message originated in a channel of the SaaS application, the monitoring service can determine the number of members of the channel based on the message metadata or based on querying the SaaS application with an indication of the channel (e.g., with an identifier or channel/message board name) for this information.

At block 503, the monitoring service computes an exposure score for the URL based on the determined number of users. The exposure score indicates a number, proportion, etc. of users of the SaaS application for which URL sharing is being monitored (e.g., a number of users associated with a tenant such as an organization that has licensed the SaaS application) that have been exposed to the malicious/phishing URL. The exposure score that the monitoring service computes may be the raw number of users to which the URL has been exposed in the context of the SaaS application (i.e., the number of users determined at block 501). As another example, the monitoring service can determine the exposure score based on normalizing the determined number of users such that the exposure score is computed based on a number of users exposed to the URL relative to a total number of users of the SaaS application (e.g., by computing a normalized value between 0 and 1 based on the determined number of users and the total number of users of the SaaS application associated with the tenant) such that the exposure score indicates a percentage, proportion, etc. of users of the SaaS application associated with the tenant that have been exposed to the URL. The monitoring service may determine the total number of users of the SaaS application based on a tenant configuration or data/metadata maintained for the tenant of the SaaS application for which URL sharing is being monitored.

At block 505, the monitoring service determines if the exposure score exceeds a threshold. The threshold can be represented as a raw value, a percentage, a proportion, etc. based on which the exposure score is evaluated. As an illustrative example, the threshold can be established at 20% (or an equivalent representation) such that exposure of the URL to at least 20% of users of the SaaS application results in the exposure score exceeding the threshold. If the exposure score exceeds the threshold, operations continue at block 507. If not, operations are complete.

At block 507, the monitoring service indicates that the URL should be prioritized for remediation. The URL should be prioritized for remediation because a substantial number of users (i.e., a number of users that exceeds a threshold) have been exposed to the URL known to be malicious or related to phishing. This may be the case if the URL was shared in a channel having a large number of users as members as opposed to a direct message with a smaller number of recipients or a smaller channel with fewer members. The monitoring service can generate a notification, alert, report, etc. that indicates that the URL should be prioritized for remediation. For instance, the notification, alert, report, etc. can be directed to security personnel to prompt investigation of the user from which the URL originated.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 can be performed in parallel or concurrently across groups of messages. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a "circuit," "module" or "system." The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine- readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

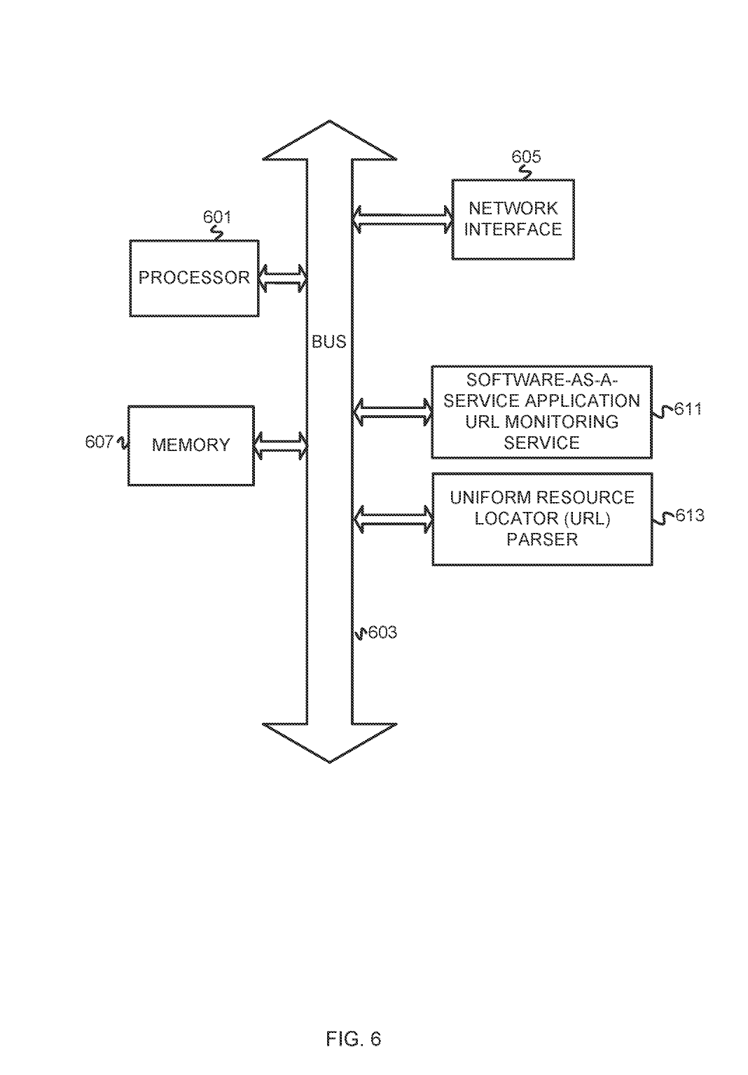

FIG. 6 depicts an example computer system with a SaaS application URL monitoring service and a URL parser. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes SaaS application URL monitoring service 611 and URL parser 613. The SaaS application URL monitoring service 611 detects unsafe URLs (e.g., malicious URLs, phishing URLs, etc.) and risky URLs shared in messages sent within a SaaS application and modifies the messages that include unsafe/risky URLs to remove or modify the URLs in the messages. The URL parser 613 executes in a secure, isolated environment and parses modified URLs to retrieve resources corresponding to unknown but risky URLs and load the resources in the secure environment. While depicted as part of the same computer system in FIG. 6 to aid in illustration, the SaaS application URL monitoring service 611 and the URL parser 613 do not necessarily execute as part of the same system. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:for each message of a plurality of messages sent within a Software-as-a-Service (SaaS) application,obtaining content of the message from the SaaS application,based on determining that the message comprises a first uniform resource locator (URL), extracting the URL from the message;determining a category of the URL, wherein the category of the first URL indicates at least one of whether the first URL is malicious and a risk level of the first URL; andmodifying the message in the SaaS application to modify or delete the first URL in the message based on the category of the first URL, wherein modifying the message based on the category of the URL comprises modifying or deleting the first URL in the message based on determining that the category of the first URL indicates that the first URL is at least one of malicious and high risk.

2. The method of claim 1, wherein modifying the first URL in the message comprises,appending the first URL to a second URL to create a third URL, wherein the second URL corresponds to a secure environment; andreplacing the first URL in the message with the third URL, wherein navigating to the third URL loads a resource corresponding to the first URL in the secure environment.

3. The method of claim 2, wherein appending the first URL to the second URL comprises appending a query string to the second URL that comprises the first URL.

4. The method of claim 2, wherein modifying the first URL in the message is based on determining that the category of the first URL indicates that the first URL is unknown and high risk.

5. The method of claim 1, further comprising subscribing to messages sent within the SaaS application via an application programming interface (API) of the SaaS application, wherein modifying the message in the SaaS application comprises modifying the message via the API of the SaaS application.

6. The method of claim 1, wherein determining the category of the URL comprises forwarding the first URL to a URL analyzer and determining the category of the first URL based on a response obtained from the URL analyzer.

7. The method of claim 1, wherein determining the category of the first URL comprises determining if the first URL is at least one of a phishing URL, a malicious URL, a benign URL, an unknown URL, a low risk URL, and a high risk URL,
wherein determining that the category of the first URL indicates that the first URL is at least one of malicious and high risk comprises determining that the category of the first URL indicates that the first URL is at least one of a phishing URL, a malicious URL, and a high risk URL.

8. The method of claim 7, further comprising:based on determining that the URL is a phishing URL, determining exposure of the phishing URL among users of the SaaS application based at least partly on a number of users of the SaaS application with which the phishing URL has been shared; andprioritizing remediation of the phishing URL based on determining that the phishing URL has had high exposure.

9. The method of claim 1, wherein the SaaS application is a collaboration-based SaaS application.

10. One or more non-transitory machine-readable media having program code stored thereon, the program code comprising instructions to:based on detection of a message sent within a Software-as-a-Service (SaaS) application, obtain content of the message;
determine whether the message includes a first uniform resource locator (URL);based on a determination that the message includes a first URL, extract the first URL from the message;categorize the first URL into one of a plurality of categories, wherein the category of the first URL indicates at least one of whether the first URL is malicious and a risk level of the first URL; andmodify the message in the SaaS application to modify or delete the first URL in the message based on the category of the first URL, wherein the instructions to modify the message based on the category of the first URL comprise instructions to modify or delete the first URL in the message based on a determination that the first URL is at least one of malicious and high risk.

11. The non-transitory machine-readable media of claim 10, wherein the instructions to modify the URL in the message comprise instructions to,append the first URL to a second URL to create a third URL, wherein the second URL corresponds to an isolated environment; andreplace the first URL in the message with the third URL, wherein navigation to the third URL loads a resource corresponding to the first URL in the isolated environment.

12. The non-transitory machine-readable media of claim 10, wherein the program code further comprises instructions to subscribe to messages sent within the SaaS application via an application programming interface (API) of the SaaS application,
wherein the instructions to modify the message in the SaaS application comprise instructions to modify the message via the API of the SaaS application.

13. The non-transitory machine-readable media of claim 10, wherein the instructions to categorize the first URL comprise instructions to forward the first URL to a URL analyzer and categorize the first URL based on a response obtained from the URL analyzer.

14. The non-transitory machine-readable media of claim 10, wherein the program code further comprises instructions to:based on a determination that the category of the first URL indicates that the first URL is a phishing URL, determine an exposure score of the first URL indicating exposure of the first URL among users of the SaaS application based at least partly on a number of users of the SaaS application with which the first URL has been shared; andprioritize remediation of the first URL based on a determination that the exposure score of the first URL exceeds a threshold.

15. An apparatus comprising:a processor; anda machine-readable medium having instructions stored thereon that are executable by the processor to cause the apparatus to,based on detection of a message sent within a Software-as-a-Service (SaaS) application, obtain content of the message;based on a determination that the message includes a first uniform resource locator (URL), extract the first URL from the message;determine a category of the first URL, wherein the wherein the category of the first URL indicates at least one of whether the first URL is malicious and a risk level of the first URL; and modify the message in the SaaS application to modify or delete the first URL in the message based on the category of the first URL, wherein the instructions executable by the processor to cause the apparatus to modify the message based on the category of the first URL comprise instructions executable by the processor to cause the apparatus to modify or delete the first URL in the message based on a determination that the category of the first URL indicates that the first URL is at least one of malicious and high risk.

16. The apparatus of claim 15, wherein the instructions executable by the processor to cause the apparatus to modify the URL in the message comprise instructions executable by the processor to cause the apparatus to,append the first URL to a second URL to create a third URL, wherein the second URL corresponds to an isolated environment; andreplace the first URL in the message with the third URL, wherein navigation to the third URL loads a resource corresponding to the first URL in the isolated environment.

17. The apparatus of claim 16, wherein the instructions executable by the processor to cause the apparatus to append the first URL to the second URL comprises instructions executable by the processor to cause the apparatus to append a query string that comprises the first URL to the second URL.

18. The apparatus of claim 15, further comprising instructions executable by the processor to cause the apparatus to subscribe to messages sent within the SaaS application via an application programming interface (API) of the SaaS application,
wherein the instructions executable by the processor to cause the apparatus to modify the message in the SaaS application comprise instructions executable by the processor to cause the apparatus to modify the message via the API of the SaaS application.

19. The apparatus of claim 15, wherein the instructions executable by the processor to cause the apparatus to determine the category of the first URL comprise instructions executable by the processor to cause the apparatus to forward the first URL to a URL analyzer and determine the category of the first URL based on a response obtained from the URL analyzer.

20. The apparatus of claim 15, further comprising instructions executable by the processor to cause the apparatus to:based on a determination that the category of the first URL indicates that the first URL is a phishing URL, determine exposure of the first URL among users
of the SaaS application based at least partly on a number of users of the SaaS application with which the first URL has been shared; andprioritize remediation of the first URL based on a determination that the first URL has had high exposure.
